(19) United States
(12) Patent Application Publication
(10) Pub. No.: US 2018/0365743 A1
(43) Pub. Date: Dec. 20, 2018

(54) Billing System and Billing Method Configured to Combine Usage Fees of Electronic Device and Cloud Service

(71) Applicant: Kyocera Document Solutions Inc., Osaka (JP)

(72) Inventor: Masaya Okuda, Osaka (JP)

(21) Appl. No.: 16/010,459

(22) Filed: Jun. 16, 2018

(30) Foreign Application Priority Data
Jun. 16, 2017 (JP) 2017-118384
Jun. 16, 2017 (JP) 2017-118385

(51) Int. Cl. G06Q 30/04; G06F 21/10

(52) U.S. Cl. CPC G06Q 30/04; G06F 2221/0773; G06F 21/105

(57) ABSTRACT

A billing system includes a service-usage-fee calculator, a device-usage-fee calculator, and a billing amount creating unit. The service-usage-fee calculator calculates a usage fee of a cloud service according to information on use of the cloud service used by an electronic device. The device-usage-fee calculator calculates a usage fee of the electronic device. The billing amount creating unit creates a billing amount by combining the usage fee calculated by the service-usage-fee calculator and the usage fee calculated by the device-usage-fee calculator.

### INCORPORATION BY REFERENCE

This application is based upon, and claims the benefit of priority from, corresponding Japanese Patent Application Nos. 2017-118384 and 2017-118385, each filed in the Japan Patent Office on Jun. 16, 2017, the entire contents of which are incorporated herein by reference.

### BACKGROUND

Unless otherwise indicated herein, the description in this section is not prior art to the claims in this application and is not admitted to be prior art by inclusion in this section.

There has been known a technique that combines and manages a usage fee of a printer and a usage fee of an Internet provider.

### SUMMARY

A billing system according to one aspect of the disclosure includes a service-usage-fee calculator, a device-usage-fee calculator, and a billing amount creating unit. The service-usage-fee calculator calculates a usage fee of a cloud service according to information on use of the cloud service used by an electronic device. The device-usage-fee calculator calculates a usage fee of the electronic device. The billing amount creating unit creates a billing amount by combining the usage fee calculated by the service-usage-fee calculator and the usage fee calculated by the device-usage-fee calculator.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a block diagram of a billing system according to a first embodiment of the disclosure.

FIG. 2 illustrates one example of a sales channel of an MFP included in the billing system according to the first embodiment.

FIG. 3 illustrates a block diagram of the MFP according to the first embodiment.

FIG. 4 illustrates a block diagram of a license server according to the first embodiment.

FIG. 5 illustrates a block diagram of a provider terminal according to the first embodiment.

FIG. 6 illustrates behaviors of the billing system according to the first embodiment when the MFP is activated.

FIG. 7 illustrates behaviors of the billing system according to the first embodiment when a cloud service is activated.

FIG. 8 illustrates behaviors of the billing system according to the first embodiment when the MFP is used.

FIG. 9 illustrates behaviors of the billing system according to the first embodiment when the cloud service is used by the MFP.

FIG. 10 illustrates behaviors of the cloud service according to the first embodiment when the cloud service is used based on an activated license.

FIG. 11 illustrates behaviors of the billing system according to the first embodiment when a billing amount is created.

FIG. 12 illustrates a block diagram of a billing system according to a second embodiment of the disclosure.

FIG. 13 illustrates a block diagram of a license server according to the second embodiment.

FIG. 14 illustrates behaviors of the billing system according to the second embodiment when the billing amount is created.

FIG. 15 illustrates behaviors of the billing system according to the first embodiment when the billing amount is created according to a first modification.

FIG. 16 illustrates behaviors of the billing system according to the second embodiment when the billing amount is created according to a second modification.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes embodiments of the disclosure with reference to the drawings.

### First Embodiment

First, the following describes a configuration of a billing system according to the first embodiment of the disclosure.

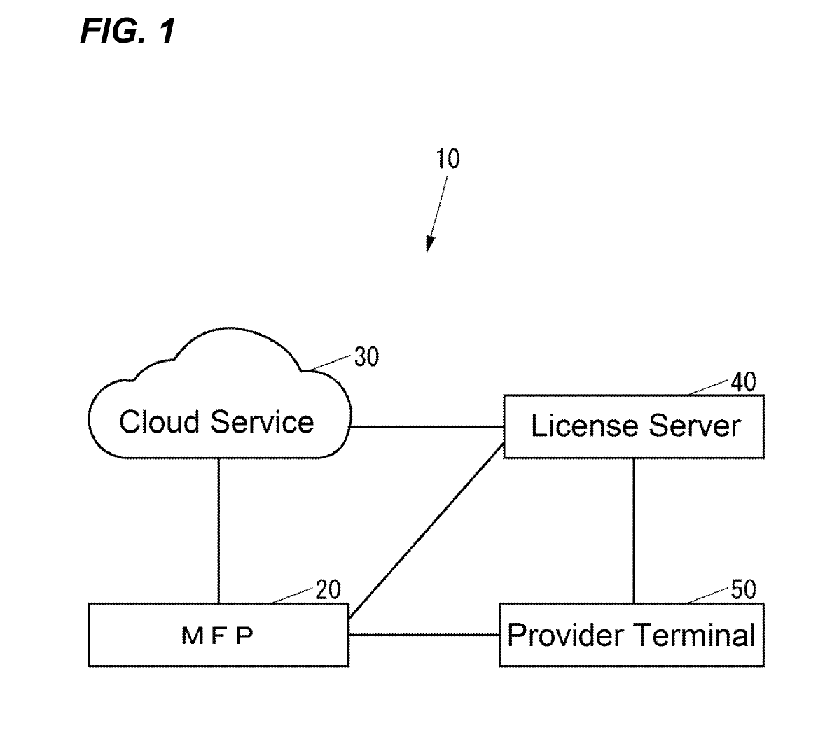

FIG. 1 illustrates a block diagram of a billing system 10 according to the embodiment.

As illustrated in FIG. 1, the billing system 10 includes a multifunction peripheral (MFP) 20 as an electronic device, a cloud service 30 used by the MFP 20, a license server 40 that manages a license of the MFP 20 and a license of the cloud service 30, and a provider terminal 50 used by a provider of the MFP 20.

The billing system 10 can include an MFP having a configuration similar to that of the MFP 20 by one or more besides the MFP 20.

The cloud service 30 is achieved by a server such as a cloud server. As the cloud service 30, various services such as a storage service, an optical character recognition (OCR) service, a translation service, and an image conversion service can be employed. The storage service stores image data created by scanning by the MFP included in the billing system 10. The OCR service extracts character information from the image data created by the scanning by the MFP included in the billing system 10. The translation service translates the characters extracted from the image data created by the scanning by the MFP included in the billing system 10. The image conversion service executes a specific image conversion process on the image data created by the scanning by the MFP included in the billing system 10.

A provider of the cloud service 30 may be different from the provider of the MFP included in the billing system 10.

The billing system 10 can include a cloud service having a configuration similar to that of the cloud service 30 by one or more besides the cloud service 30.

The billing system 10 can include a provider terminal having a configuration similar to that of the provider terminal 50 by one or more besides the provider terminal 50. The billing system 10 includes the provider terminal for each provider of the MFP.

The MFP included in the billing system 10 and the cloud service 30 included in the billing system 10 are communicable via a network such as the Internet. The MFP included in the billing system 10 and the provider terminal included in the billing system 10 are communicable via a network such as the Internet. The MFP and the license server 40, which are included in the billing system 10, are communicable via a network such as the Internet. The cloud service 30 and the license server 40, which are included in the billing system 10, are communicable via a network such as the Internet. The license server 40 and the provider terminal included in the billing system 10 are communicable via a network such as the Internet.

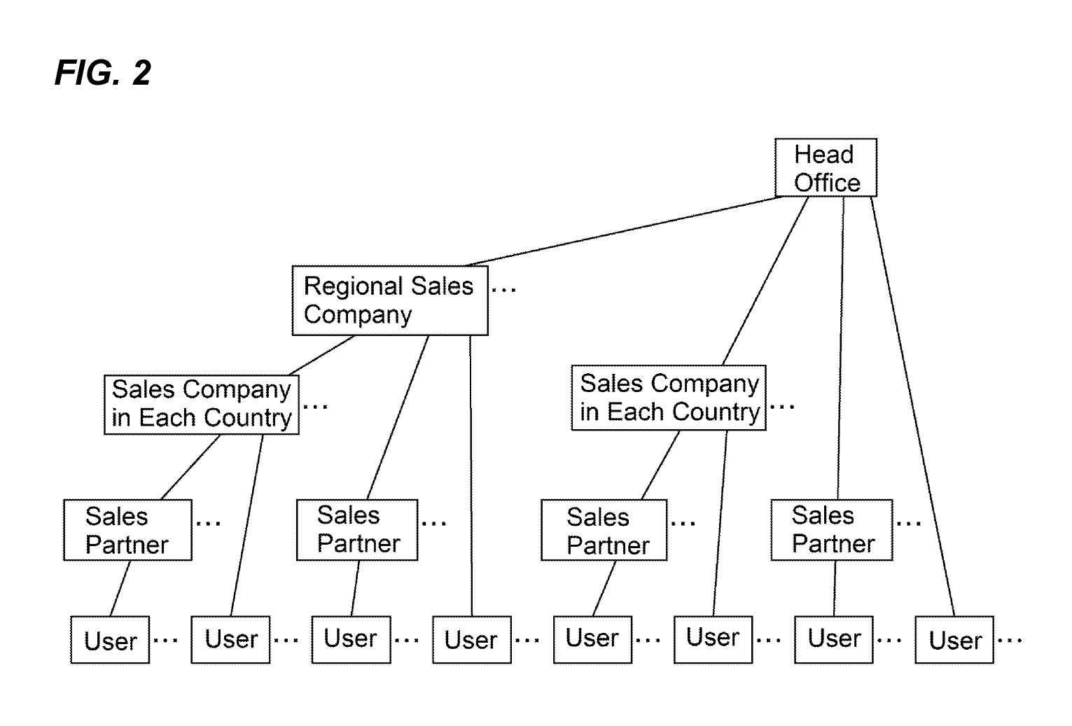

FIG. 2 illustrates one example of a sales channel of the MFP included in the billing system 10.

As illustrated in FIG. 2, there may be a case where the head office of a manufacturing company of the MFPs provides the MFP to each of: a regional sales company that covers a region constituted of a plurality of countries as a provided range of the MFPs, a sales company in each country that covers one country as the provided range of the MFPs, a sales partner that covers a region as a part of one country as the provided range of the MFPs, and a user of the MFP. In this case, assuming that the head office is the provider of the MFP, each of the regional sales company, the sales company in each country, the sales partner, and the user to which the MFP is provided from the head office is a provision destination of the head office. Accordingly, the head office as the provider of the MFPs needs to charge a usage fee of the MFP to each of the regional sales company, the sales company in each country, the sales partner, and the user as the provision destinations for the head office itself. There may be a case where each of the regional sales company, the sales company in each country, the sales partner, and the user to which the MFP is provided from the head office are plural.

There may be a case where the regional sales company provides the MFP to each of the sales company in each country, the sales partner, and the user of the MFP. In this case, assuming that the regional sales company is the provider of the MFP, each of the sales company in each country, the sales partner, and the user to which the MFP is provided from the regional sales company is a provision destination for the regional sales company. Accordingly, the regional sales company as the provider of the MFPs needs to charge the usage fee of the MFP to each of the sales company in each country, the sales partner, and the user as the provision destinations for the regional sales company itself. There may be a case where each of the sales company in each country, the sales partner, and the user to which the MFP is provided from the one regional sales company are plural.

There may be a case where the sales company in each country provides the MFP to each of the sales partner and the user of the MFP. In this case, assuming that the sales company in each country as the provider of the MFP, each of the sales partner and the user to which the MFP is provided from the sales company in each country are provision destinations for the sales company in each country. Accordingly, the sales company in each country as the provider of the MFP needs to charge the usage fee of the MFP to each of the sales partner and the user as the provision destinations for the sales company in each country itself. There may be a case where each of the sales partner and the user to which the MFP is provided from the one sales company in each country are plural.

The sales partner provides the MFP to the user of the MFP. In this case, assuming that the sales partner as the provider of the MFP, the user to which the MFP is provided from the sales partner is the provision destination for the sales partner. Accordingly, the sales partner as the provider of the MFP needs to charge the usage fee of the MFP to the user as the provision destination for the sales partner itself. There may be a case where the user to which the MFP is provided from the one sales partner is plural.

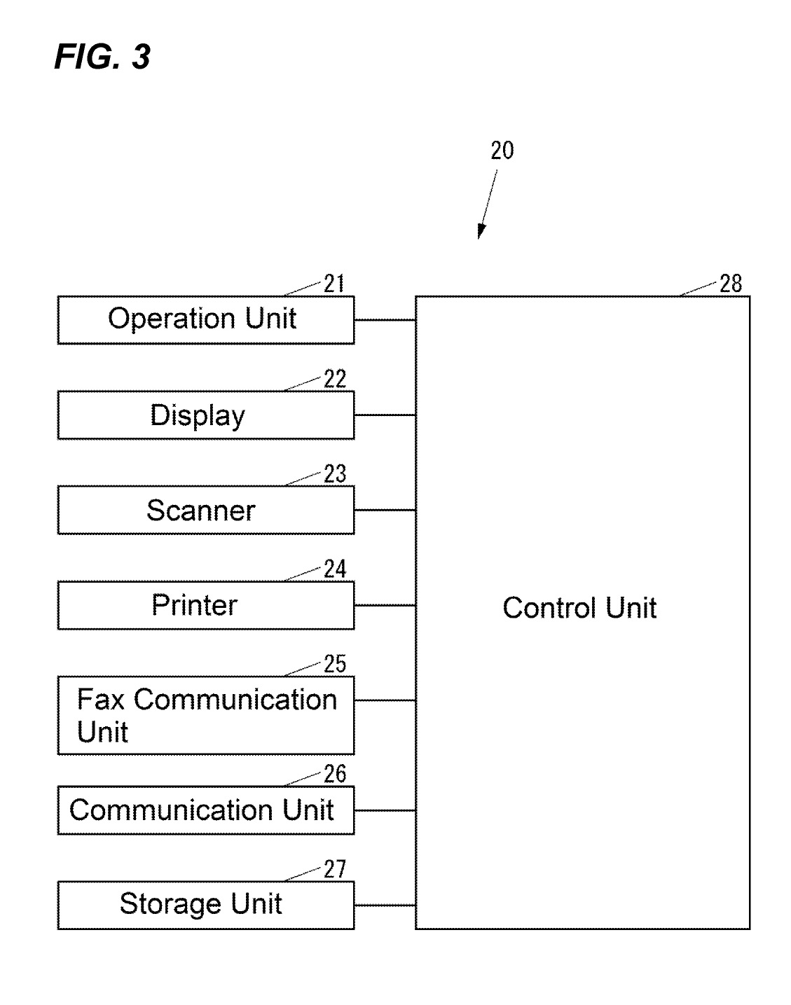

FIG. 3 illustrates a block diagram of the MFP 20.

As illustrated in FIG. 3, the MFP 20 includes an operation unit 21 as an input device such as a button with which various operations are input, a display 22 as a display device such as a liquid crystal display (LCD), which displays various kinds of information, a scanner 23 as a reading device, which reads images from documents, a printer 24 as a print device, which prints the images on recording mediums such as paper sheets, a fax communication unit 25 as a fax device, which performs fax communications via a communication line such as a dial-up line with an external facsimile device (not illustrated), a communication unit 26 as a communication device, which communicates with an external device via a network or directly by wired or wireless connection without via the network, a storage unit 27 as a non-volatile storage device such as a semiconductor memory and a hard disk drive (HDD), which stores various kinds of information, and a control unit 28, which controls the whole MFP 20.

The control unit 28 includes, for example, a central processing unit (CPU), a read-only memory (ROM) that stores programs and various kinds of data, and a random-access memory (RAM) used as a work area of the CPU. The CPU executes the programs stored in the ROM or the storage unit 27.

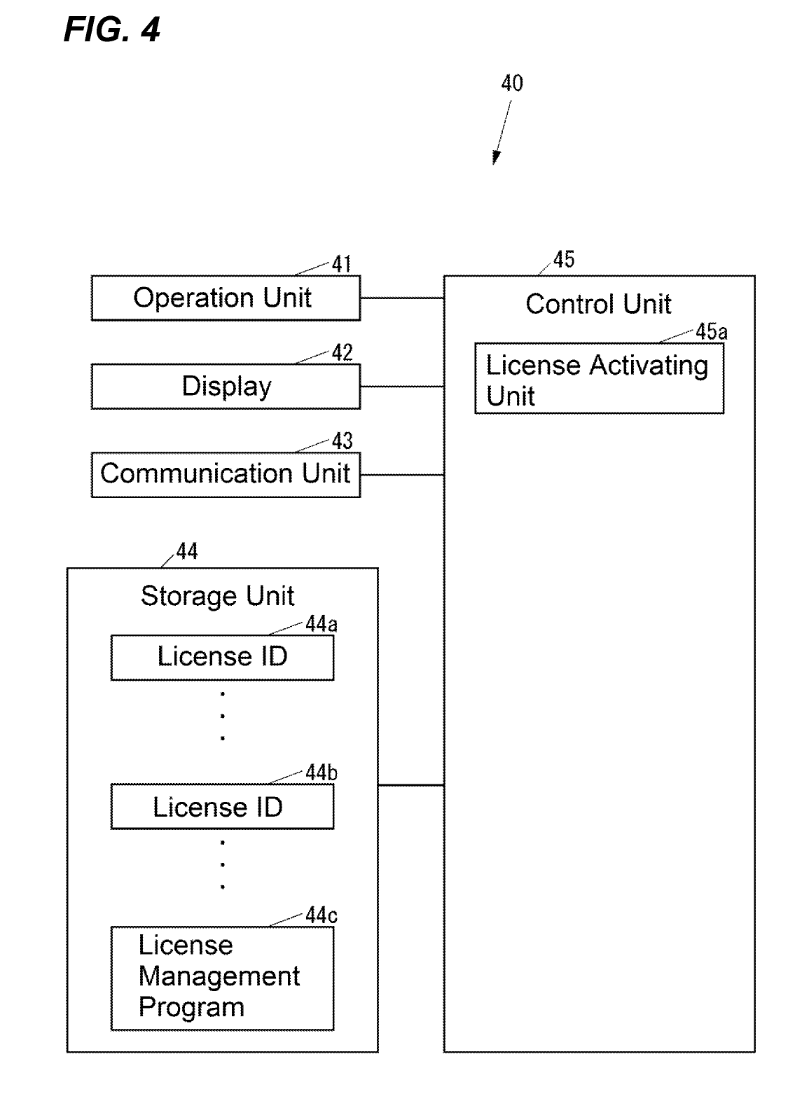

FIG. 4 illustrates a block diagram of the license server 40.

As illustrated in FIG. 4, the license server 40 includes an operation unit 41 as an input device such as a keyboard and a computer mouse with which various operations are input, a display 42 as a display device such as an LCD that displays various kinds of information, a communication unit 43 as a communication device that communicates with an external device via a network or directly by wired or wireless connection without via the network, a storage unit 44 as a non-volatile storage device such as a semiconductor memory and an HDD that stores various kinds of information, and a control unit 45 that controls the whole license server 40. The license server 40 is, for example, a computer such as a Personal Computer (PC).

The storage unit 44 can store a license ID 44a indicative of the license of the MFP included in the billing system 10. The storage unit 44 can include a license ID having a configuration similar to that of the license ID 44a by one or more besides the license ID 44a.

The storage unit 44 can store a license ID 44b indicative of the license of the cloud service included in the billing system 10. The storage unit 44 can include a license ID having a configuration similar to that of the license ID 44b by one or more besides the license ID 44b.

The storage unit 44 stores a license management program 44c to manage the license of the MFP included in the billing system 10 and the license of the cloud service included in the billing system 10. The license management program 44c may be installed into the license server 40 at a production stage of the license server 40, may be additionally installed into the license server 40 from an external storage medium such as a universal serial bus (USB) memory, a compact disk (CD), and a digital versatile disk (DVD), or may be additionally installed into the license server 40 from the network.

The control unit 45 includes, for example, a CPU, a ROM that stores programs and various kinds of data, and a RAM used as a work area of the CPU. The CPU executes the programs stored in the ROM or the storage unit 44.

The control unit 45 executes the license management program 44c to achieve the license and a license activating unit 45a that activates the license.

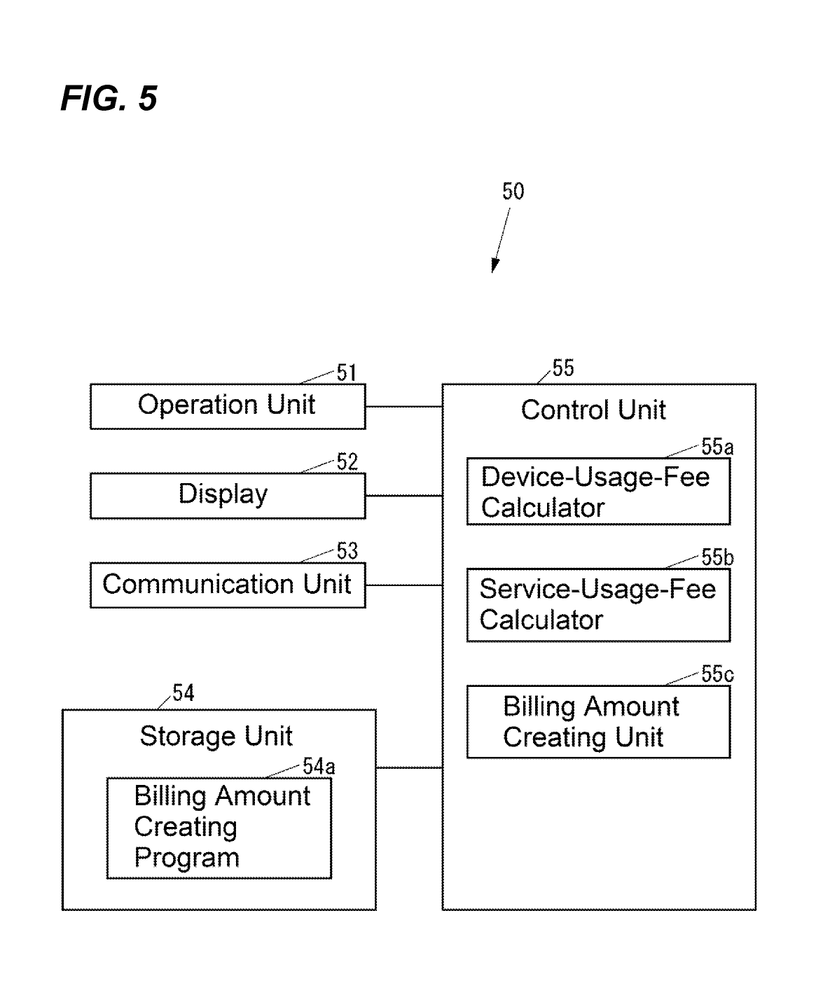

FIG. 5 illustrates a block diagram of the provider terminal 50.

As illustrated in FIG. 5, the provider terminal 50 includes an operation unit 51 as an input device such as a keyboard and a computer mouse with which various operations are input, a display 52 as a display device such as an LCD that displays various kinds of information, a communication unit 53 as a communication device that communicates with an external device via a network or directly by wired or wireless connection without via the network, a storage unit 54 as a non-volatile storage device such as a semiconductor memory and an HDD that stores various kinds of information, and a control unit 55 that controls the whole provider terminal 50. The provider terminal 50 is, for example, a computer such as a PC.

The storage unit 54 stores a billing amount creating program 54a to create the billing amount from the provider of the MFP to the provision destination. The billing amount creating program 54a may be installed into the provider terminal 50 at a production stage of the provider terminal 50, may be additionally installed into the provider terminal 50 from an external storage medium such as a USB memory, a CD, and a DVD, or may be additionally installed into the provider terminal 50 from the network.

The control unit 55 includes, for example, a CPU, a ROM that stores programs and various kinds of data, and a RAM used as a work area of the CPU. The CPU executes the programs stored in the ROM or the storage unit 54.

The control unit 55 executes the billing amount creating program 54a to achieve a device-usage-fee calculator 55a that calculates the usage fee of the MFP, a service-usage-fee calculator 55b that calculates the usage fee of the cloud service, and a billing amount creating unit 55c that creates the billing amount combining the usage fee calculated by the device-usage-fee calculator 55a and the usage fee calculated by the service-usage-fee calculator 55b.

Next, the following describes behaviors of the billing system 10.

First, the following describes the behaviors of the billing system 10 when the MFP 20 is activated.

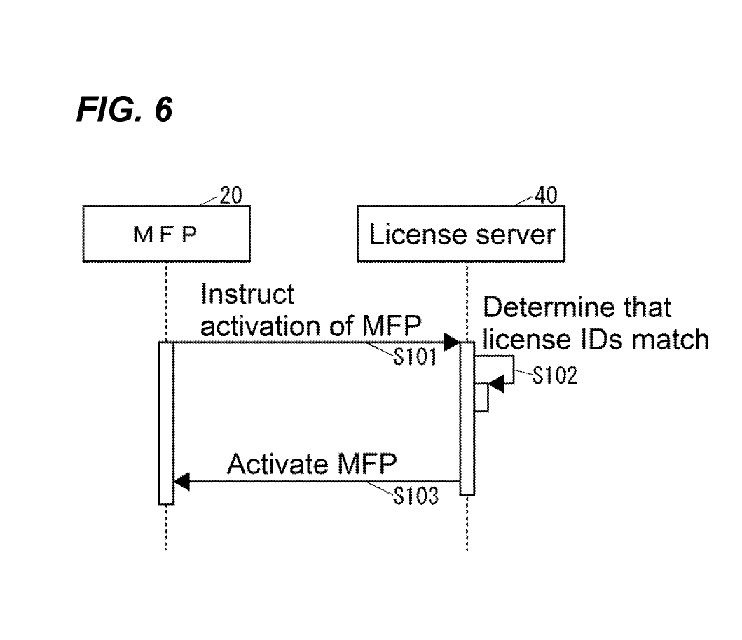

FIG. 6 illustrates the behaviors of the billing system 10 when the MFP 20 is activated.

For example, the provider of the MFP 20 provides a license ID for the MFP 20 to the user of the MFP 20. The user of the MFP 20 can input the license ID for the MFP 20 to the MFP 20 via the operation unit 21.

As illustrated in FIG. 6, when the license ID for the MFP 20 is input, the control unit 28 in the MFP 20 transmits the input license ID to the license server 40 to instruct the license server 40 to activate the MFP 20 (Step S101).

When the activation of the MFP 20 is instructed, the license activating unit 45a in the license server 40 determines whether the license ID transmitted from the MFP 20 matches the license ID for the MFP 20 stored in the storage unit 44 or not (Step S102).

When the license activating unit 45a determines that the license ID transmitted from the MFP 20 matches the license ID for the MFP 20 stored in the storage unit 44 at Step S102, the license activating unit 45a performs the activation on the MFP 20 (Step S103).

Thus, the user of the MFP 20 can use the MFP 20.

While the example where the MFP 20 instructs the license server 40 to activate the MFP 20 has been described above, a computer other than the MFP 20 can also instruct the license server 40 to activate the MFP 20.

Next, the following describes behaviors of the billing system 10 when the cloud service 30 is activated.

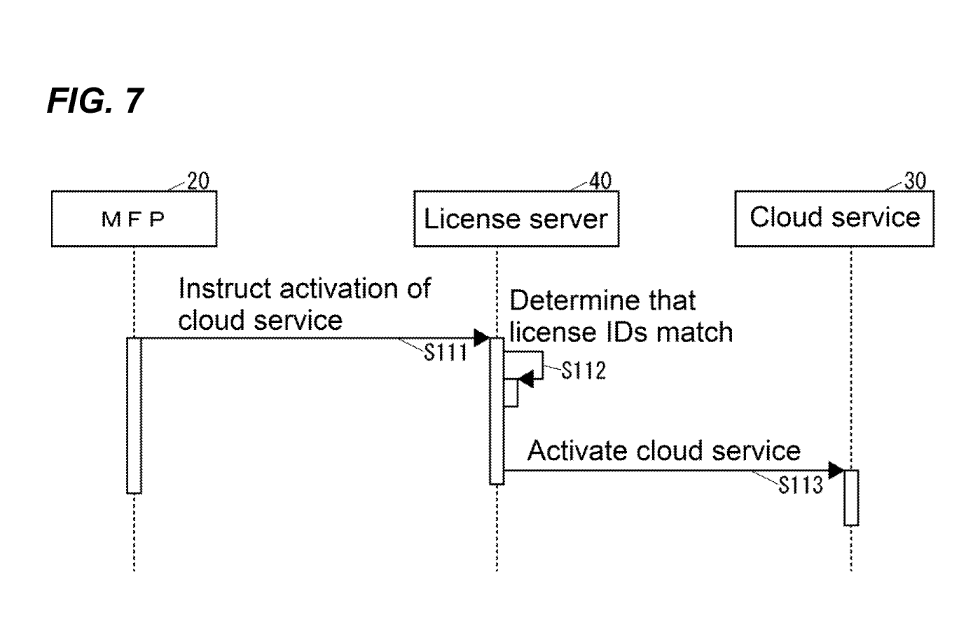

FIG. 7 illustrates the behaviors of the billing system 10 when the cloud service 30 is activated.

For example, the provider of the cloud service 30 provides a license ID for the cloud service 30 to the user of the MFP 20. The user of the MFP 20 can input the license ID for the cloud service 30 to the MFP 20 via the operation unit 21.

As illustrated in FIG. 7, when the license ID for the cloud service 30 is input, the control unit 28 in the MFP 20 transmits the input license ID to the license server 40 to instruct the license server 40 to activate the cloud service 30 (Step S111).

When the activation of the cloud service 30 is instructed, the license activating unit 45a in the license server 40 determines whether the license ID transmitted from the MFP 20 matches the license ID for the cloud service 30 stored in the storage unit 44 or not (Step S112).

When the license activating unit 45a determines that the license ID transmitted from the MFP 20 matches the license ID for the cloud service 30 stored in the storage unit 44 at Step S112, the license activating unit 45a performs the activation on the cloud service 30 (Step S113).

Thus, the user of the MFP 20 can use the cloud service 30 using the MFP 20.

The cloud service 30 manages an amount of use of the cloud service 30 for each activated license.

While the example where the MFP 20 instructs the license server 40 to activate the cloud service 30 has been described above, a computer other than the MFP 20 can also instruct the license server 40 to activate the cloud service 30.

Next, the following describes behaviors of the billing system 10 when the MFP 20 is used.

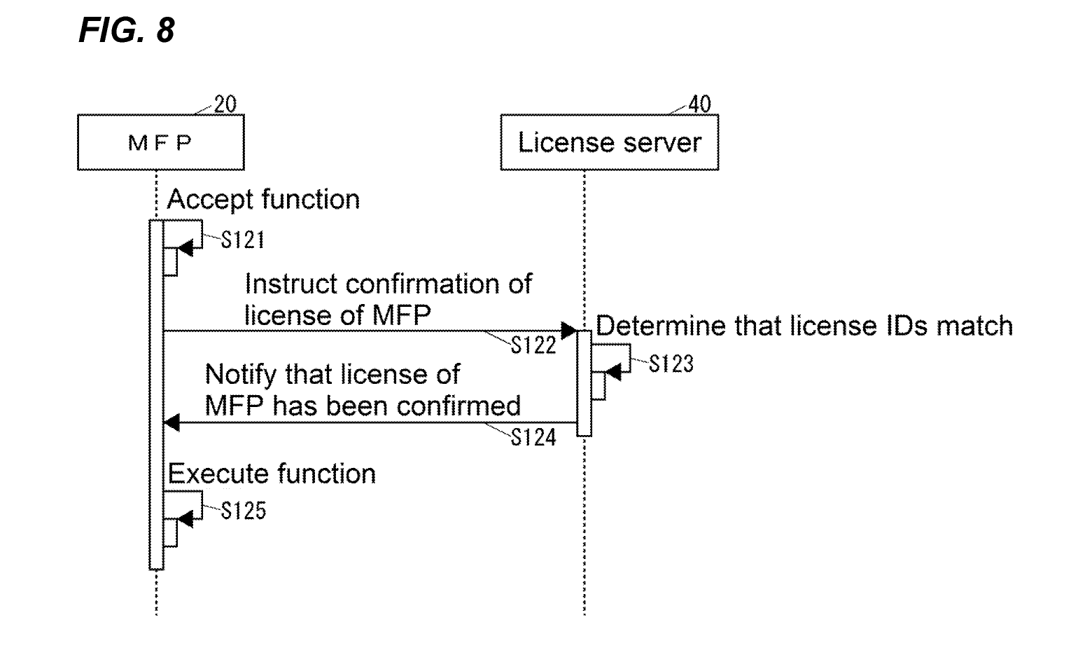

FIG. 8 illustrates the behaviors of the billing system 10 when the MFP 20 is used.

As illustrated in FIG. 8, when the execution of the function of the MFP 20 is instructed via the operation unit 21, the control unit 28 in the MFP 20 accepts the function instructed to be executed (Step S121).

Next, the control unit 28 transmits the license ID for the MFP 20 to the license server 40 to Instruct the license server 40 to confirm the license of the MFP 20 (Step S122).

When the confirmation of the license of the MFP 20 is instructed, the license activating unit 45a in the license server 40 determines whether the license ID transmitted from the MFP 20 matches the license ID for the MFP 20 stored in the storage unit 44 or not (Step S123).

When the license activating unit 45a determines that the license ID transmitted from the MFP 20 matches the license ID for the MFP 20 stored in the storage unit 44 at Step S123, the license activating unit 45a notifies the MFP 20 of the fact that the license of the MFP 20 has been confirmed (Step S124).

When the fact that the license of the MFP 20 has been confirmed is notified from the license server 40, the control unit 28 in the MFP 20 executes the function accepted at Step S121 (Step S125).

Next, the following describes behaviors of the billing system 10 when the cloud service 30 is used by the MFP 20.

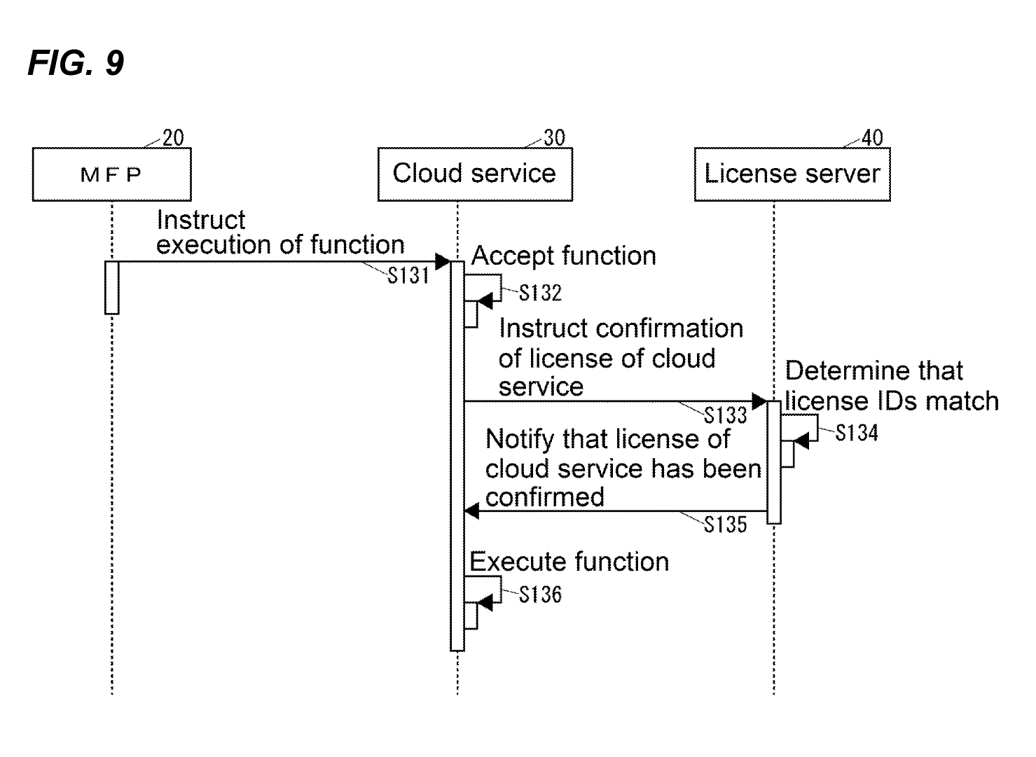

FIG. 9 illustrates the behaviors of the billing system 10 when the cloud service 30 is used by the MFP 20.

As illustrated in FIG. 9, when the execution of the function using the cloud service 30 is instructed via the operation unit 21 in the MFP 20, the control unit 28 in the MFP 20 instructs the cloud service 30 to execute the function instructed to be executed (Step S131). Here, the control unit 28 notifies the cloud service 30 of the license ID for the cloud service 30.

When the execution of the function is instructed from the MFP 20, the cloud service 30 accepts the function instructed to be executed (Step S132).

Next, the cloud service 30 transmits the license ID for the cloud service 30 notified from the MFP 20 to the license server 40 to instruct the license server 40 to confirm the license of the cloud service 30 (Step S133).

When the confirmation of the license of the cloud service 30 is instructed, the license activating unit 45a in the license server 40 determines whether the license ID transmitted from the cloud service 30 matches the incense ID for the cloud service 30 stored in the storage unit 44 or not (Step S134).

When the license activating unit 45a determines that the license ID transmitted from the cloud service 30 matches the license ID for the cloud service 30 stored in the storage unit 44 at Step S134, the license activating unit 45a notifies the cloud service 30 of the fact that the license of the cloud service 30 has been confirmed (Step S135).

When the fact that the license of the cloud service 30 has been confirmed is notified from the license server 40, the cloud service 30 executes the function accepted at Step S132 (Step S136).

Since the function of the MFP 20 is also executed when the cloud service 30 is used by the MFP 20, the behaviors illustrated in FIG. 8 may be executed in addition to the behaviors illustrated in FIG. 9.

Next, the following describes behaviors of the cloud service 30 when the cloud service 30 is used based on the activated license.

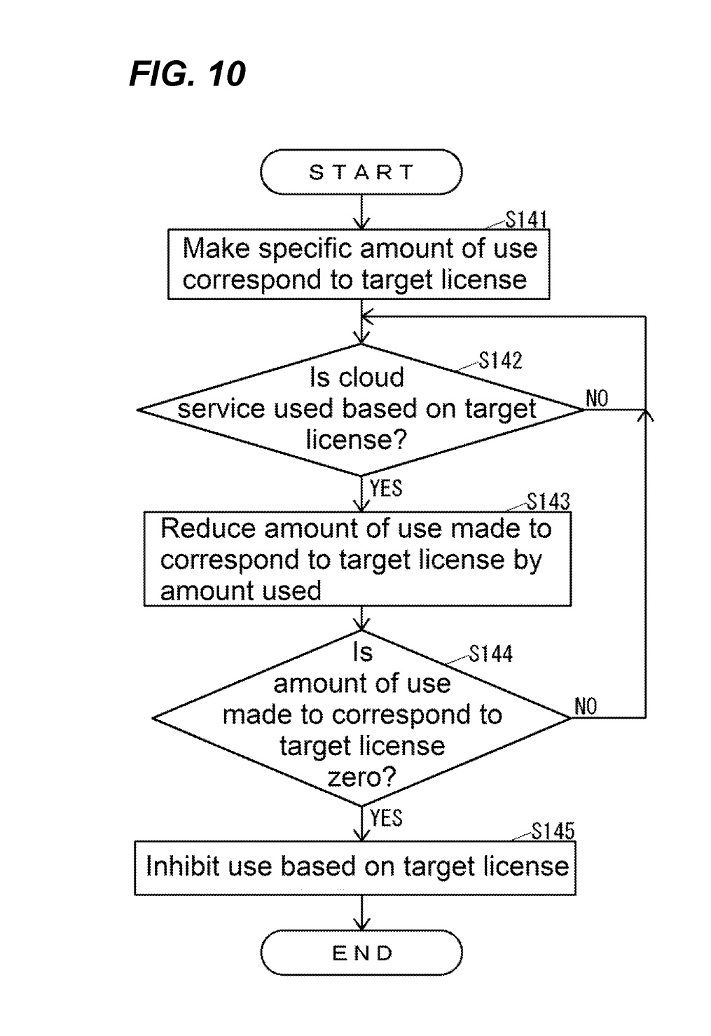

FIG. 10 illustrates the behaviors of the cloud service 30 when the cloud service 30 is used based on the activated license.

As described above, the cloud service 30 manages the amount of use of the cloud service 30 for each activated license. Accordingly, the cloud service 30 performs the behaviors illustrated in FIG. 10 whenever the activation is performed at Step S113.

As illustrated in FIG. 10, the cloud service 30 makes a specific amount of use such as 1000 correspond to the license (hereinafter referred to as “target license”) activated at Step S113 performed immediately before (Step S141).

Next, whether the cloud service 30 is used based on the target license at Step S136 or not is determined until determined as being used based on the target license at Step S136 (Step S142).

At Step S142, when it is determined that the cloud service 30 has been used at Step S136 based on the target license, the amount of use made to correspond to the target license is reduced by the amount used at Step S136 (Step S143).

Next, the cloud service 30 determines whether the amount of use made to correspond to the target license is zero or not (Step S144).

When the cloud service 30 determines that the amount of use made to correspond to the target license is not zero at Step S144, the cloud service 30 performs the process at Step S142.

When the cloud service 30 determines that the amount of use made to correspond to the target license is zero at Step S144, the cloud service 30 inhibits the use based on the target license (Step S145) and terminates the behaviors illustrated in FIG. 10.

Next, the following describes behaviors of the billing system 10 when the billing amount is created.

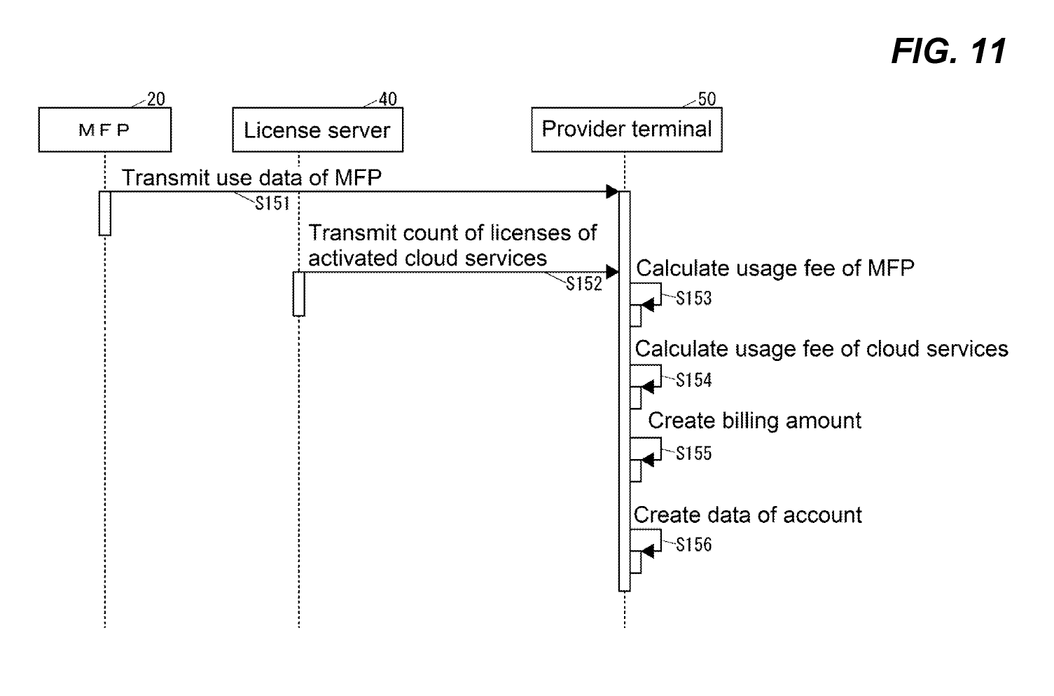

FIG. 11 illustrates the behaviors of the billing system 10 when the billing amount is created.

As illustrated in FIG. 11, the control unit 28 in the MFP 20 transmits use data indicative of the amount of use of the MFP 20 to the provider terminal 50 (Step S151). Here, the process at Step S151 may be performed whenever the MFP 20 is used or may be performed regularly, for example, every day. The amount of use indicated by the use data transmitted at Step S151 is the amount of use after the execution of the previous process of Step S151.

The license activating unit 45a in the license server 40 transmits a count of licenses of the activated cloud services 30 to the provider terminal 50 as information on use (Step S152). Here, the process at Step S152 is performed regardless of the process at Step S151. The process at Step S152 may be performed whenever the license of the cloud service 30 is activated by the license server 40 or may be performed regularly, for example, every day. The count transmitted at Step S152 is the count after the execution of the previous process of Step S152.

The device-usage-fee calculator 55a in the provider terminal 50 calculates the usage fee of the MFP 20 according to the amount of use of the MFP 20 indicated by the use data transmitted from the MFP 20 at Step S151 (Step S153). Here, the process at Step S153 is performed regularly, for example, the end of month of every month. The process at Step S153 targets all processes of Step S151 performed after the execution of the previous process of Step S153 to calculate the usage fee of the MFP 20 after the execution of the previous process of Step S153.

The service-usage-fee calculator 55b in the provider terminal 50 calculates the usage fee of the cloud services 30 according to the count of licenses of the cloud services 30 transmitted from the license server 40 at Step S152 (Step S154). Here, the process at Step S154 is performed regularly, for example, the end of month of every month. The process at Step S154 targets all processes of Step S152 performed after the execution of the previous process of Step S154 to calculate the usage fee of the cloud services 30 after the execution of the previous process of Step S154.

The billing amount creating unit 55c in the provider terminal 50 creates the billing amount combining the usage fee calculated at Step S153 and the usage fee calculated at Step S154 (Step S155) and creates data of an account of the billing amount created at Step S155 (Step S156).

Accordingly, the user of the provider terminal 50, namely, the provider of the MFP 20 can print the account based on the data created at Step S156 and pass the printed account to the provision destination of the MFP.

At least a part of the processes of Steps S153 to S156 may be manually performed by the user of the provider terminal 50.

As described above, since the billing system 10 calculates the usage fee of the cloud services 30 according to the count of licenses of the activated cloud services 30 (Step S154), the usage fee of the cloud services 30 used by the MFPs 20 can be highly accurately calculated. Accordingly, the billing system 10 can highly accurately create the billing amount combining the usage fee of the MFP 20 and the usage fee of the cloud service 30 used by the MFP 20.

When the provider of the cloud service 30 differs from the provider of the MFP included in the billing system 10, the provider of the MFP included in the billing system 10 pays for the usage fee of the cloud service 30 collected from the provision destination of the MFP to the provider of the cloud service 30 by any method. In this case, the provider of the MFP may change the amount of money of the usage fee of the cloud service 30 collected from the provision destination of the MFP and pay for the changed amount of money to the provider of the cloud service 30.

With the billing system 10, the provider of the MFP can charge the usage fee of the cloud service 30 provided by a person other than the provider of the MFP, namely, a third person to the provision destination of the MFP. Accordingly, the provider of the MFP can achieve flexible pricing, such as setting a unit price for the usage fee of the MFP high instead of setting the unit price for the usage fee of the cloud service low and setting the unit price for the usage fee of the MFP low instead of setting the unit price for the usage fee of the cloud service high. For example, when an MFP other than the latest model is provided to the user, the provider of the MFP can reduce lowering an offered price of the MFP under a condition of setting the unit price for the usage fee of the cloud service low.

The billing system 10 can cause the provider of the MFP to recognize the use situation of the cloud service 30 provided by the person other than the provider of the MFP, namely, the third person. Accordingly, the provider of the MFP can perform various proposals based on the use situation of the cloud service 30 using the MFP to the user of the MFP.

Since the billing system 10 manages the license of the cloud service and the license of the MFP by the identical license server 40, the simple configuration can be achieved.

### Second Embodiment

First, the following describes a configuration of a billing system according to the second embodiment of the disclosure.

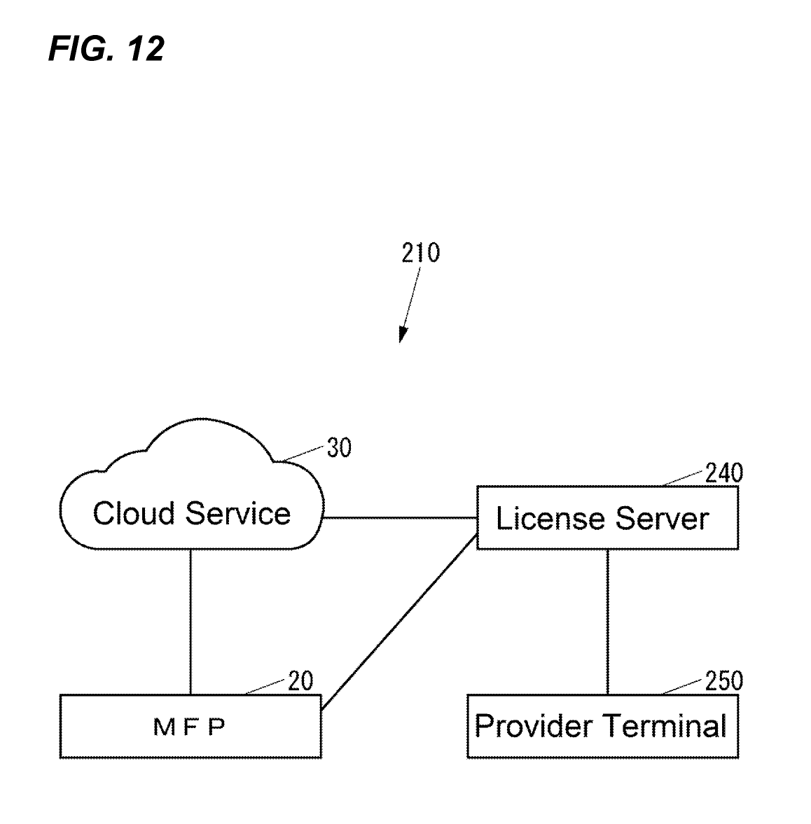

FIG. 12 illustrates a block diagram of a billing system 210 according to the embodiment.

As illustrated in FIG. 12, the billing system 210 has a configuration similar to the configuration of the billing system 10 (see FIG. 1) that includes a license server 240 and a provider terminal 250 instead of the license server 40 (see FIG. 1) and the provider terminal 50 (see FIG. 1).

The provider terminal 250 has a configuration similar to the configuration of the provider terminal 50 without the billing amount creating program 54a (see FIG. 5).

The billing system 210 can include a provider terminal having a configuration similar to that of the provider terminal 250 by one or more besides the provider terminal 250. The billing system 210 includes the provider terminal for each provider of the MFP.

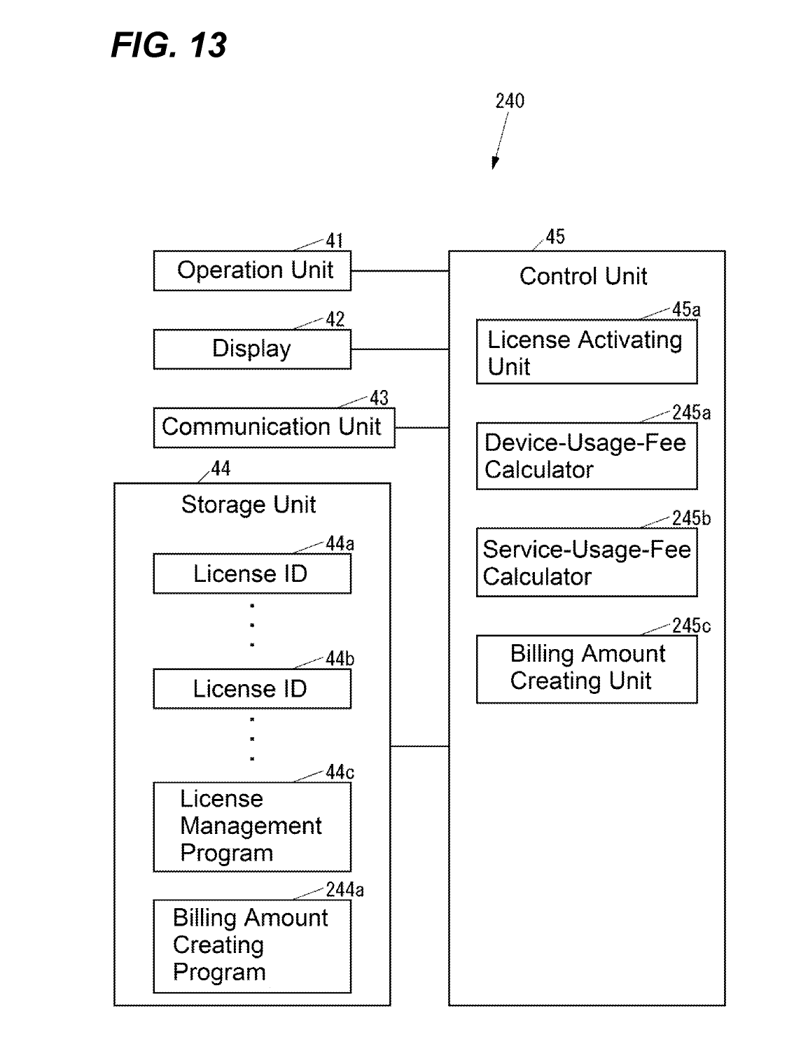

FIG. 13 illustrates a block diagram of the license server 240.

As illustrated in FIG. 13, the license server 240 has a configuration similar to the configuration of the license server 40 (see FIG. 4) that includes a billing amount creating program 244a to create the billing amount from the provider of the MFP to the provision destination of the MFP. The billing amount creating program 244a may be installed into the license server 240 at a production stage of the license server 240, may be additionally installed into the license server 240 from an external storage medium such as a USB memory, a CD, and a DVD, or may be additionally installed into the license server 240 from the network.

The control unit 45 executes the billing amount creating program 244a to achieve a device-usage-fee calculator 245a that calculates the usage fee of the MFP, a service-usage-fee calculator 245b that calculates the usage fee of the cloud service, and a billing amount creating unit 245c that creates the billing amount combining the usage fee calculated by the device-usage-fee calculator 245a and the usage fee calculated by the service-usage-fee calculator 245b.

Next, the following describes behaviors of the billing system 210.

The behaviors of the billing system 210 are similar to the behaviors of the billing system 10 excluding the behavior to create the billing amount.

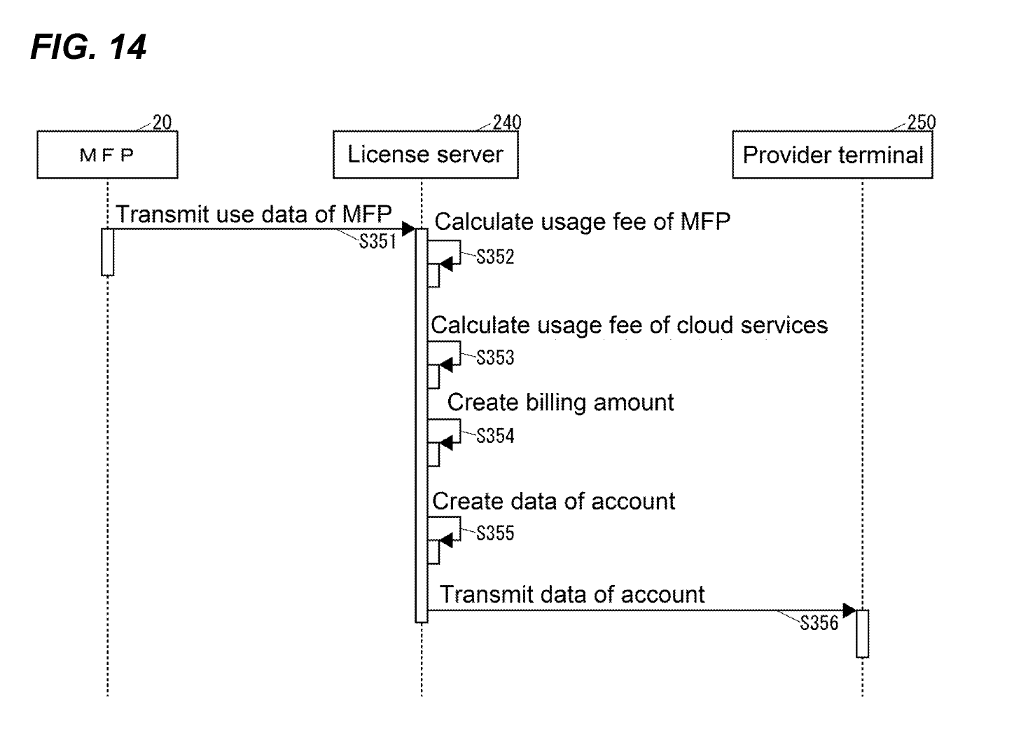

FIG. 14 illustrates the behaviors of the billing system 210 when the billing amount is created.

As illustrated in FIG. 14, the control unit 28 in the MFP 20 transmits the use data indicative of the amount of use of the MFP 20 to the license server 240 as information on the use (Step S351). Here, the process at Step S351 may be performed whenever the MFP 20 is used or may be performed regularly, for example, every day. The amount of use indicated by the use data transmitted at Step S351 is the amount of use after the execution of the previous process of Step S351.

The device-usage-fee calculator 245a in the license server 240 calculates the usage fee of the MFP 20 according to the amount of use of the MFP 20 indicated by the use data transmitted from the MFP 20 at Step S351 (Step S352). Here, the process at Step S352 is performed regularly, for example, the end of month of every month. The process at Step S352 targets all processes of Step S351 performed after the execution of the previous process of Step S352 to calculate the usage fee of the MFP 20 after the execution of the previous process of Step S352.

The service-usage-fee calculator 245b in the license server 240 calculates the usage fee of the cloud services 30 according to the count of licenses of the cloud services 30 activated by the license activating unit 45a (Step S353). Here, the process at Step S353 is performed regularly, for example, the end of month of every month. The process at Step S353 targets all licenses of the cloud services 30 activated after the execution of the previous process of Step S353 to calculate the usage fee of the cloud services 30 after the execution of the previous process of Step S353.

The billing amount creating unit 245c in the license server 240 creates the billing amount combining the usage fee calculated at Step S352 and the usage fee calculated at Step S353 (Step S354) and creates data of an account of the billing amount created at Step S354 (Step S355).

The billing amount creating unit 245c transmits the data created at Step S355 to the provider terminal 250 (Step S356).

Accordingly, the user of the provider terminal 250, namely, the provider of the MFP 20 can print the account based on the data transmitted from the license server 240 at Step S356 and pass the printed account to the provision destination of the MFP.

Not the transmission of the data of the account from the license server 240 to the provider terminal 250, but the account printed based on the data created at Step S355 may be transmitted to the provider of the MFP.

The billing system 210 can obtain the following effects in addition to the effects obtained by the billing system 10. The billing system 210 performs all of the activation of the license of the cloud service, the calculation of the usage fee of the MFP (Step S352), the calculation of the usage fee of the cloud service (Step S353), and the creation of the billing amount (Step S354) by the license server 240; therefore, the simple configuration can be achieved. That is, the billing system 210 ensures reducing a processing load taken on the provider terminal for each of the head office, the regional sales company, the sales company in each country, and the sales partner.

Each embodiment described above charges the usage fee of the cloud service by the method where the usage fee by the specific amount of use is generated before the cloud service is actually used. On the other hand, each embodiment described above charges the usage fee of the MFP by the method where the fee according to the actual amount of use is generated. However, the usage fee of the MFP may be charged by a method where the usage fee by the specific amount of use is generated before the MFP is actually used.

### First Modification

Next, the following describes behaviors of the billing system 10 according to the first modification when the billing amount is created.

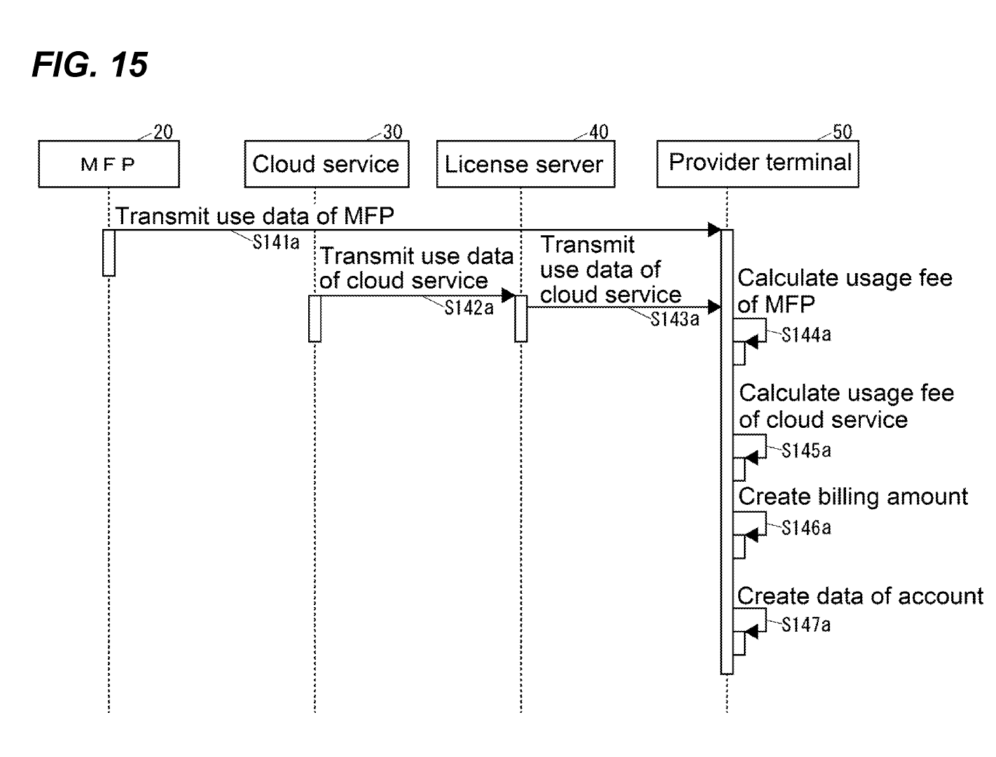

FIG. 15 illustrates the behaviors of the billing system 10 according to the first modification when the billing amount is created.

As illustrated in FIG. 15, the control unit 28 in the MFP 20 transmits the use data indicative of the amount of use of the MFP 20 to the provider terminal 50 as information on the use (Step S141a). Here, the process at Step S141a may be performed whenever the MFP 20 is used or may be performed regularly, for example, every day. The amount of use indicated by the use data transmitted at Step S141a is the amount of use after the execution of the previous process of Step S141a.

The cloud service 30 transmits use data indicative of the amount of use of the cloud service 30 to the license server 40 (Step S142a). Here, the process at Step S142a is performed regardless of the process at Step S141a. The process at Step S142a may be performed whenever the cloud service 30 is used or may be performed regularly, for example, every day. The amount of use indicated by the use data transmitted at Step S142a is the amount of use after the execution of the previous process of Step S142a.

Whenever the license server 40 receives the use data from the cloud service 30, the license server 40 transmits the use data received from the cloud service 30 to the provider terminal 50 (Step S143a).

The device-usage-fee calculator 55a in the provider terminal 50 calculates the usage fee of the MFP 20 according to the amount of use of the MFP 20 indicated by the use data transmitted from the MFP 20 at Step S141a (Step S144a ). Here, the process at Step S144a is performed regularly, for example, the end of month of every month. The process at Step S144a targets all processes of Step S141a performed after the execution of the previous process of Step S144a to calculate the usage fee of the MFP 20 after the execution of the previous process of Step S144a.

The service-usage-fee calculator 55b in the provider terminal 50 calculates the usage fee of the cloud service 30 according to the amount of use of the cloud service 30 indicated by the use data transmitted from the license server 40 at Step S143a (Step S145a ). Here, the process at Step S145a is performed regularly, for example, the end of month of every month. The process at Step S145a targets all processes of Step S143a performed after the execution of the previous process of Step S145a to calculate the usage fee of the cloud service 30 after the execution of the previous process of Step S145a.

The billing amount creating unit 55c in the provider terminal 50 creates the billing amount combining the usage fee calculated at Step S144a and the usage fee calculated at Step S145a (Step S146a) and creates data of an account of the billing amount created at Step S146a (Step S147a).

Accordingly, the user of the provider terminal 50, namely, the provider of the MFP 20 can print the account based on the data created at Step S147a and pass the printed account to the provision destination of the MFP.

At least a part of the processes of Steps S144a to S147a may be manually performed by the user of the provider terminal 50.

As described above, since the billing system 10 calculates the usage fee of the cloud services 30 according to the use data of the cloud service obtained from the cloud services used by the MFP (Step S145a), the usage fee of the cloud service 30 used by the MFP 20 can be highly accurately calculated. Accordingly, the billing system 10 can highly accurately create the billing amount combining the usage fee of the MFP 20 and the usage fee of the cloud service 30 used by the MFP 20.

When the provider of the cloud service 30 differs from the provider of the MFP included in the billing system 10, the provider of the MFP included in the billing system 10 pays for the usage fee of the cloud service 30 collected from the provision destination of the MFP to the provider of the cloud service 30 by any method. In this case, the provider of the MFP may change the amount of money of the usage fee of the cloud service 30 collected from the provision destination of the MFP and pay for the changed amount of money to the provider of the cloud service 30.

With the billing system 10, the provider of the MFP can charge the usage fee of the cloud service 30 provided by a person other than the provider of the MFP, namely, a third person to the provision destination of the MFP. Accordingly, the provider of the MFP can achieve flexible pricing, such as setting a unit price for the usage fee of the MFP high instead of setting the unit price for the usage fee of the cloud service low and setting the unit price for the usage fee of the MFP low instead of setting the unit price for the usage fee of the cloud service high. For example, when an MFP other than the latest model is provided to the user, the provider of the MFP can reduce lowering an offered price of the MFP under a condition of setting the unit price for the usage fee of the cloud service low.

The billing system 10 can cause the provider of the MFP to recognize the use situation of the cloud service 30 provided by the person other than the provider of the MFP, namely, the third person. Accordingly, the provider of the MFP can perform various proposals based on the use situation of the cloud service 30 using the MFP to the user of the MFP.

Since the billing system 10 manages the license of the cloud service and the license of the MFP by the identical license server 40, the simple configuration can be achieved.

### Second Modification

Next, the following describes behaviors of the billing system 210 according to the second modification.

The behaviors of the billing system 210 according to the second modification are similar to the behaviors of the billing system 10 according to the first modification excluding the behavior to create the billing amount.

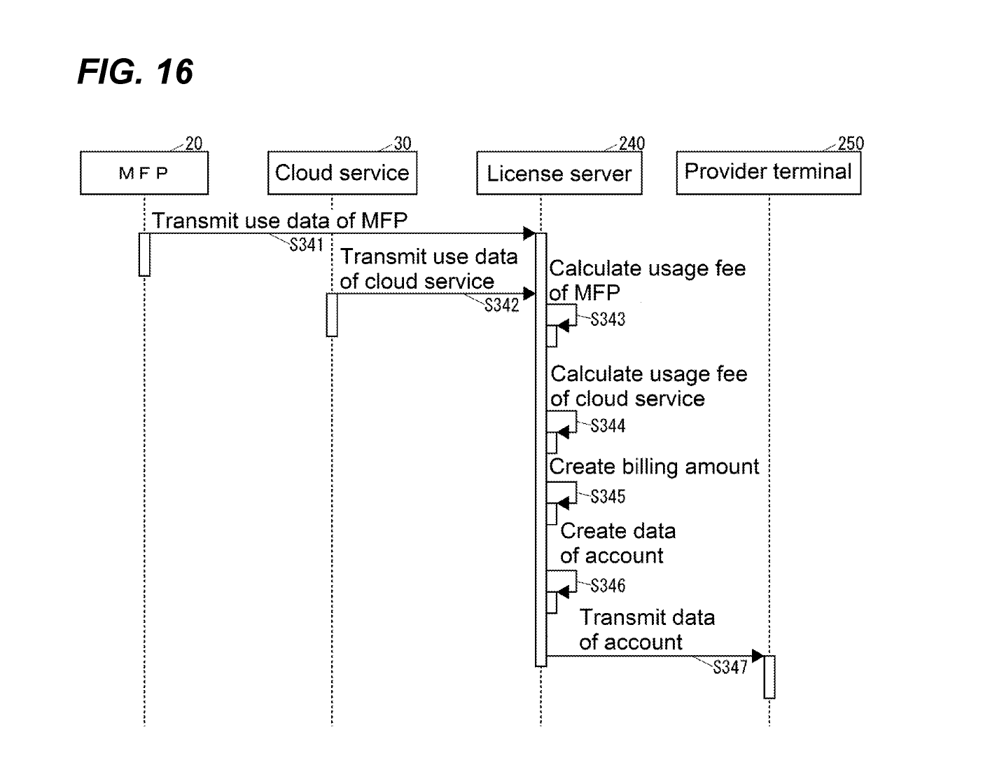

FIG. 16 illustrates the behaviors of the billing system 210 when the billing amount is created.

As illustrated in FIG. 16, the control unit 28 in the MFP 20 transmits the use data indicative of the amount of use of the MFP 20 to the license server 240 (Step S341). Here, the process at Step S341 may be performed whenever the MFP 20 is used or may be performed regularly, for example, every day. The amount of use indicated by the use data transmitted at Step S341 is the amount of use after the execution of the previous process of Step S341.

The cloud service 30 transmits use data indicative of the amount of use of the cloud service 30 to the license server 240 (Step S342). Here, the process at Step S342 is performed regardless of the process at Step S341. The process at Step S342 may be performed whenever the cloud service 30 is used or may be performed regularly, for example, every day. The amount of use indicated by the use data transmitted at Step S342 is the amount of use after the execution of the previous process of Step S342.

The device-usage-fee calculator 245a in the license server 240 calculates the usage fee of the MFP 20 according to the amount of use of the MFP 20 indicated by the use data transmitted from the MFP 20 at Step S341 (Step S343). Here, the process at Step S343 is performed regularly, for example, the end of month of every month. The process at Step S343 targets all processes of Step S341 performed after the execution of the previous process of Step S343 to calculate the usage fee of the MFP 20 after the execution of the previous process of Step S343.

The service-usage-fee calculator 245b in the license server 240 calculates the usage fee of the cloud service 30 according to the amount of use of the cloud service 30 indicated by the use data transmitted from the cloud service 30 at Step S342 (Step S344). Here, the process at Step S344 is performed regularly, for example, the end of month of every month. The process at Step S344 targets all licenses of the cloud services 30 activated after the execution of the previous process of Step S344 to calculate the usage fee of the cloud services 30 after the execution of the previous process of Step S344.

The billing amount creating unit 245c in the license server 240 creates the billing amount combining the usage fee calculated at Step S343 and the usage fee calculated at Step S344 (Step S345) and creates data of an account of the billing amount created at Step S345 (Step S346).

The billing amount creating unit 245c transmits the data created at Step S346 to the provider terminal 250 (Step S347).

Accordingly, the user of the provider terminal 250, namely, the provider of the MFP 20 can print the account based on the data transmitted from the license server 240 at Step S347 and pass the printed account to the provision destination of the MFP.

Not the transmission of the data of the account from the license server 240 to the provider terminal 250, but the account printed based on the data created at Step S346 may be transmitted to the provider of the MFP.

The billing system 210 can obtain the following effects in addition to the effects obtained by the billing system 10. The billing system 210 performs all of the activation of the license of the cloud service, the calculation of the usage fee of the MFP (Step S343), the calculation of the usage fee of the cloud service (Step S344), and the creation of the billing amount (Step S345) by the license server 240; therefore, the simple configuration can be achieved. That is, the billing system 210 ensures reducing a processing load taken on the provider terminal for each of the head office, the regional sales company, the sales company in each country, and the sales partner.

Each embodiment described above charges the usage fee of the cloud service by the method where the fee according to the actual amount of use is generated. Similarly, each embodiment described above charges the usage fee of the MFP by the method where the fee according to the actual amount of use is generated. However, the usage fee of the MFP may be charged by a method where the usage fee by the specific amount of use is generated before the MFP is actually used.

While the electronic device of the disclosure is the MFP in each embodiment described above, the electronic device may be an image forming apparatus other than the MFP, such as a printer-only machine, a copy-only machine, a FAX-only machine, and a scanner-only machine, or may be an electronic device other than the image forming apparatus such as a PC.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A billing system comprising:
a service-usage-fee calculator that calculates a usage fee of a cloud service according to information on use of the cloud service used by an electronic device;
a device-usage-fee calculator that calculates a usage fee of the electronic device; and
a billing amount creating unit that creates a billing amount by combining the usage fee calculated by the service-usage-fee calculator and the usage fee calculated by the device-usage-fee calculator.

2. The billing system according to claim 1, further comprising:
a license activating unit that activates a license of the cloud service used by the electronic device; wherein
the information on the use includes a count of the licenses of the cloud services activated by the license activating unit.

3. The billing system according to claim 2, further comprising:
a license server that manages the license of the cloud service and a license of the electronic device; wherein
the license server includes the license activating unit.

4. The billing system according to claim 3, wherein the license server further includes the service-usage-fee calculator, the device-usage-fee calculator, and the billing amount creating unit.

5. The billing system according to claim 1, wherein the information on the use includes use data, the use data indicating an amount of use of the cloud service obtained from the cloud service.

6. The billing system according to claim 5, further comprising:
a license server that manages a license of the cloud service; wherein the license server includes
a license activating unit that activates the license of the cloud service, and
the service-usage-fee calculator, the device-usage-fee calculator, and the billing amount creating unit.

7. The billing system according to claim 5, wherein the license server manages a license of the electronic device.

8. A billing method comprising:
calculating a usage fee of a cloud service according to information on use of the cloud service used by an electronic device;
calculating a usage fee of the electronic device; and
creating a billing amount by combining the usage fee calculated by the calculation of the usage fee of the cloud service and the usage fee calculated by the calculation of the usage fee of the electronic device.

9. The billing method according to claim 8, further comprising:
activating a license of the cloud service used by the electronic device; wherein
the information on the use includes a count of the licenses of the cloud services activated by the activating.

10. The billing method according to claim 8, wherein the information on the use includes use data, the use data indicating an amount of use of the cloud service obtained from the cloud service.
